(19) United States
(12) Patent Application Publication
(10) Pub. No.: US 2007/0224900 A1
(43) Pub. Date: Sep. 27, 2007

(54) ARTICLES AND METHODS PROVIDING ANTIMICROBIAL AND VAPOR BARRIER PROPERTIES

(75) Inventor: Vincent Tucker, Colorado Springs, CO (US)

Correspondence Address: CALFEE HALTER & GRISWOLD, LLP, 800 SUPERIOR AVENUE, SUITE 1400, CLEVELAND, OH, 44114, US

(73) Assignee: TUCKER SAFETY PRODUCTS, Colorado Springs, CO (US)

(21) Appl. No.: 11/690,485

(22) Filed: Mar. 23, 2007

Related U.S. Application Data
(60) Provisional application No. 60/743,811, filed on Mar. 27, 2006.

(51) Int. Cl. B32B 5/02; D03D 27/00; D03D 15/00

(52) U.S. Cl. 442/181; 428/95; 442/59

(57) ABSTRACT

Articles having vapor barrier and antimicrobial properties are provided. The articles can have a vapor barrier layer and first and/or second layers having fibers with antimicrobial agents. Additionally, methods of utilizing articles having vapor barrier and antimicrobial properties are provided.

### CROSS REFERENCE TO RELATED APPLICATION

This application claims priority to U.S. Provisional Application Ser. No. 60/743,811, filed Mar. 27, 2006, the entirety of which is incorporated by reference herein.

### BACKGROUND

Kitchen environments present a number of safety issues to workers in the kitchen. For example, hot items need to be handled and such items can often be wet or steaming. Commonly, kitchen workers handle hot items with a fibrous item such as a towel or pot holder. However, such fibrous items may not provide adequate protection in wet environments. Additionally, these fibrous items may become soiled, and the growth of certain bacteria or other microorganisms can occur on or in the fibrous items. Thus, there remains a need in the art for improved articles for use in the kitchen.

### SUMMARY

In accordance with embodiments of the invention, articles are provided. The articles can comprise a first layer having a first and second face and a second layer having a first and second face. At least one of the first layer and the second layer comprise fibers having hollow areas. At least a portion of hollow areas of at least a portion of the fibers contain an antimicrobial agent. The articles further comprise a vapor barrier layer having a first and second face. The first face of the first layer is disposed proximate to the first face of the vapor barrier layer, and the first face of the second layer is disposed proximate to the second face of the vapor barrier layer. The first and second layer and the vapor barrier are laminated together such that a vapor barrier between the first and second layer is formed.

In accordance with other embodiments of the invention, articles are provided. The articles can comprise a first layer having a first and second face, a second layer having a first and second face, and a vapor barrier layer having a first and second face. The first face of the first layer is disposed proximate to the first face of the vapor barrier layer and the first face of the second layer is disposed proximate to the second face of the vapor barrier layer. The first and second layer and the vapor barrier are laminated together such that a vapor barrier between the first and second layer is formed. At least one of the first layer and the second layer comprise fibers that have been treated with an antimicrobial agent such that the antimicrobial agent contacts at least a portion of the fibers.

In accordance with embodiments of the invention, methods of providing protection are provided. The methods comprise utilizing an article to provide protection in a kitchen environment. The article comprises a first layer having a first and second face and a second layer having a first and second face. At least one of the first layer and the second layer comprise fibers having hollow areas. At least a portion of hollow areas of at least a portion of the fibers contain an antimicrobial agent. The article further comprises a vapor barrier layer having a first and second face. The first face of the first layer is disposed proximate to the first face of the vapor barrier layer, and the first face of the second layer is disposed proximate to the second face of the vapor barrier layer. The first and second layer and the vapor barrier are laminated together such that a vapor barrier between the first and second layer is formed. In one example, the step of utilizing an article comprises utilizing the article to prevent or minimize a burn. In another example, the step of utilizing an article comprises utilizing the article to provide a vapor barrier such that a burn to a user is minimized.

In accordance with other embodiments of the invention, further methods of providing protection are provided. The methods can comprise utilizing an article to provide protection in a kitchen environment. The article can comprise a first layer having a first and second face and a second layer having a first and second face and a vapor barrier layer having a first and second face. The first face of the first layer is disposed proximate to the first face of the vapor barrier layer, and the first face of the second layer is disposed proximate to the second face of the vapor barrier layer. The first and second layer and the vapor barrier are laminated together such that a vapor barrier between the first and second layer is formed. At least one of the first layer and the second layer comprise fibers that have been treated with an antimicrobial agent such that the antimicrobial agent contacts at least a portion of the fibers

### BRIEF DESCRIPTION OF THE SEVERAL VIEWS OF THE DRAWINGS

The following detailed description of embodiments of the present invention can be best understood when read in conjunction with the following drawings, where like structure is indicated with like reference numerals and in which:

FIG. 1 is a cross-sectional view of an article in accordance with embodiments of the present invention;

FIG. 2 is a cross-sectional view of a hollow fiber in accordance with embodiments of the present invention;

FIG. 3 is a plan view of an oven mitt in accordance with embodiments of the present invention;

FIG. 4 is a cross-sectional view of FIG. 3 taken along axis A in accordance with embodiments of the present invention; and

FIG. 5 is a cross-sectional view of a fiber in accordance with embodiments of the present invention.

### DETAILED DESCRIPTION OF EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

Articles and methods that provide vapor barrier and antimicrobial protection are provided. The articles may be suitable for use in kitchen environments, such as commercial kitchens. The articles may provide a high temperature vapor barrier that prevents a user from being burned or minimizes or lessens the risk of being burned by hot items when working in a wet environment. Additionally, the articles may have antimicrobial properties that help to prevent or retard the growth of unwanted microbes on the articles.

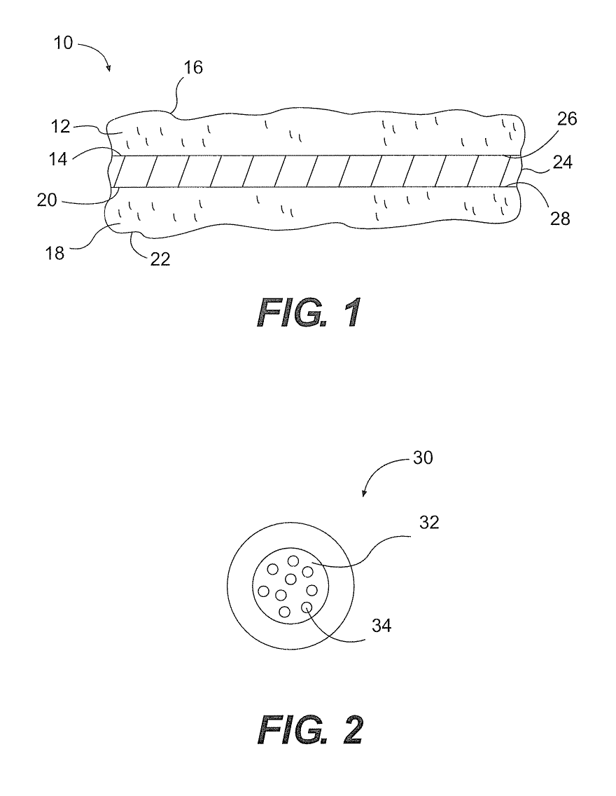

In accordance with embodiments of the present invention, articles are provided. Referring now to FIG. 1, an article 10 is illustrated. The article 10 has a first layer 12 having a first face 14 and a second face 16. The article 10 has a second layer 18 having a first face 20 and a second face 22. The article 10 has a vapor barrier layer 24 having a first face 26 and a second face 28. The first face 14 of the first layer 12 is proximate to the first face 26 of the vapor barrier layer 24. The first face 20 of the second layer 18 is proximate to the second face 28 of the vapor barrier layer 24. It will be understood that additional vapor barrier layers 24 or additional first and second layers 12, 18 could be provided. For example, the article 10 could comprise two first layers 12 proximate to one another with a vapor barrier layer 24 proximate to one of the first layers 12 and two second layers 18 proximate to one another with one of the second layers 18 proximate to the vapor barrier layer 24. Thus, it will be understood that the particular layer configuration of the article 10 can be changed in any suitable manner, including, but not limited to, any desired number of first or second layers in combination with any desired number of vapor barrier layers. In further examples, additional layers, such as cleaning, scrubbing, or cut resistant layers can be added between the first and second layers 12,18 and the vapor barrier layer 24 or proximate to the second face 16 of the first layer 12 and/or the second face 22 of the second layer 18.

Generally, the first layer 12, the second layer 18, and the vapor barrier layer 24 are laminated together such that the vapor barrier layer 24 provides a vapor barrier between the first layer 12 and the second layer 18. For example, hot vapor or liquid that penetrates the first layer 12 is prevented from contacting the second layer 18 by the vapor barrier layer 24. It will be understood that the lamination conditions under which the first layer 12, the second layer 18, and the barrier layer 24 are laminated together will vary depending on the composition of the first layer, second layer 18, and vapor barrier layer 24. For example, an adhesive (not shown) can be disposed between the vapor barrier layer 24 and the first and second layers 12, 18. After the layers 24, 12, and 18 are adhered together, a heat lamination can be performed under pressure. Any suitable adhesive, temperature, and pressure may be used for the lamination. For example, the lamination can be performed at a temperature of about 100° C. to about 400° C., downward and upward pressure of from about 0 to about 100 p.s.i., and on a moving conveyor belt at speeds from about 5 m/min to about 10 m/min.

In some embodiments, the first or second layers 12, 18 or both contain fibers having hollow areas (not shown in FIG. 1). A fiber 30 having hollow areas is illustrated in FIG. 2. The fiber 30 has hollow areas 32 in the fiber 30. The hollow areas 32 of at least a portion of the hollow fibers 30 in the first or second layers 12, 18 or both contain an antimicrobial agent 34. It will be understood that the antimicrobial agent 34 can fill all or a portion of hollow areas 32 of a particular fiber. Additionally, it will be understood that the antimicrobial agent 34 can coat the wall of the hollow area 32.

Any suitable antimicrobial agent 34 can be used, and a single antimicrobial agent or more than one antimicrobial agent can be used in some or all of the fibers 30. Generally, the antimicrobial agent 34 is selected to be suitable for use in a food preparation area. For example, silver-based antimicrobial agents such as AgION™, available from AgION Technologies Company can be used. In other examples, polymeric based antimicrobials, such as trimethoxy silyl propyl dimethyl octadecyl ammonium chloride available from AEGIS Environments under the AEGIS Microbe Shield® name, may be used. Other suitable antimicrobial agents include, but are not limited to, halogenated phenyl ethers, halogenated salicylanilides, sesquiterpene alcohols, halogenated carbanilides, bisphenolic compounds, general phenols, quaternary ammonium compounds, pyridine derivatives, zinc based compounds and hexachlorophane. Generally, the antimicrobial agents 34 are placed in at least some hollow areas 32 of fibers 30 prior to any further processing of the fibers 30. It will be understood that any suitable process can be used to place the antimicrobial agent 34 in the fibers 30. The antimicrobial agents 34 can prevent or retard the growth of certain microbes from growing on the first and second layers 12, 18. In other examples, the antimicrobial agents 34 can be added to the second face 16 of the first layer 12 and/or the second face 22 of the second layer 18 to further assist in the inhibition and/or retardation of microbe growth on the first and second layers 12,18.

It will be further understood that any suitable amount of the antimicrobial agents 34 may be used. For example, the amount of antimicrobial agents 34 may be chosen to provide an effective level of antimicrobial activity for a given application. In some examples, the antimicrobial agents 34 may comprise from about 0.01% by weight to about 5% by weight of the fibers 30. In other examples, the antimicrobial agents may comprise from about 0.07% by weight to about 0.14% by weight of the fibers 30.

The fibers 30 can be of any suitable type of fiber having hollow areas. For example, the fibers 30 can comprise polyester fibers, such as Fosshield® fibers that are available from Foss Manufacturing with AgION™ antimicrobial in the fibers. In another example, the fibers 30 can comprise Nomex®, Kevlar®, modacrylic, and/or aramid fibers. Additionally, it will be understood that the first or second layers 12, 18 or both can comprise one type of fiber 30 or more than one type of fiber 30.

Generally, the fibers 30 are woven together or blended and woven with additional fibers (not shown) to form the first layer 12 or the second layer 18 or both. In one example, the first or second layers 12, 18 or both can comprise from about 15% by weight to about 100% by weight of the fibers 30. In another example, the first or second layers 12, 18 or both can comprise about 15%, 20%, 25%, or 30% by weight of the fibers 30. Any suitable additional fibers may be used in forming the first layer 12 or the second layer 18 or both. For example, cotton, wool, polyester, Lycra®, modacrylic, Nomex®, and Kevlar® fibers can be used. In one example, the fibers 30 and the additional fibers are woven to form first or second layers 12, 18 or both, such that the first or second layers 12, 18 or both comprise woven cloth or cloth-like layers. In another example, the first and/or second layers 12, 18 can comprise a non-woven layer. A layer having any suitable weight and finish can be provided. For example, the first or second layers 12, 18 or both can comprise a woven or non-woven cloth having a finished basis weight of from about 3 ounces/square yard to about 20 ounces/square yard. In some examples, the first or second layers 12, 18 or both can have a terry cloth finish, a plain weave finish, a twill finish, or any other suitable finish. It will be understood that the first and second layers 12, 18 can have different finishes or the same finish.

In yet other embodiments, the first or second layers 12, 18 or both contain at least some fibers that have been treated with an antimicrobial agent (not shown in FIG. 1). The fibers may or may not contain hollow areas, and the antimicrobial agent 34 may contact the outside of the fiber 300 as illustrated in FIG. 5. It will be understood that the antimicrobial agent 34 may cover all or a portion of the fibers 300. It will be further understood that the antimicrobial agent 34 may or may not contact at least a portion of the hollow area of the fibers 300, when the fibers 300 have hollow areas. Any suitable antimicrobial agent 34 or combination of antimicrobial agents 34 may be used as described herein.

It will understood that any suitable amount of the antimicrobial agents 34 may be used. For example, the amount of antimicrobial agents 34 may be chosen to provide an effective level of antimicrobial activity for a given application. In some examples, the antimicrobial agents 34 may comprise from about 0.01% by weight to about 5% by weight of the fibers 300. In other examples, the antimicrobial agents may comprise from about 0.16% by weight to about 0.32% by weight of a solution used to treat the fibers 300.

The fibers 300 may be any suitable fibers or blends of fibers. For example, Nomex®, Kevlar®, modacrylic, aramid, cotton, wool, polyester, and/or Lycra® fibers may be used. The antimicrobial agent 34 can be added to the fibers 300 in any suitable manner under any suitable treatment conditions. For example, the fibers 300 may be used to form woven or non-woven cloth or cloth-like structures that are suitably treated with an antimicrobial agent 34 in any suitable manner. For example, the woven or non-woven cloth or cloth-like structure may be soaked in a bath containing at least one antimicrobial agent 34. In other examples, the woven or non-woven cloth or cloth-like structure may be pulled through a bath containing at least one antimicrobial agent. In yet further examples, the antimicrobial agent 34 may be treated onto the first and/or second layers 12, 18 as a step in the finishing of the layers. For example, the first and/or second layers 12, 18 may be formed, washed, scoured, heat set, and treated with the antimicrobial agent 34. In other examples, the fibers 300 may be treated with the antimicrobial agent prior to the formation of the first and/or second layers 12, 18. In some examples, the first and/or second layers 12, 18 are formed, treated with the antimicrobial agent 34, and laminated to other layers, as described herein. In other examples, the first and/or second layers 12, 18 are formed, laminated to other layers as described herein, and then treated with the antimicrobial agent 34. One having skill in the art will be able to select suitable treatment conditions to provide a desired amount of antimicrobial agent 34.

In one example, the fibers 300 are woven to form first or second layers 12, 18 or both, such that the first or second layers 12, 18 or both comprise woven cloth or cloth-like layers. In another example, the first and/or second layers 12, 18 can comprise a non-woven layer. A layer having any suitable weight and finish can be provided. For example, the first or second layers 12, 18 or both can comprise a woven or non-woven cloth having a finished basis weight of from about 3 ounces/square yard to about 20 ounces/square yard. In some examples, the first or second layers 12, 18 or both can have a terry cloth finish, a plain weave finish, or a twill finish. It will be understood that the first and second layers 12, 18 can have different finishes or the same finish.

The vapor barrier layer 24 can comprise any suitable vapor barrier material having any suitable thickness. The vapor barrier layer 24 is generally selected to be impermeable or resistant to the transfer of vapor or liquid through the layer 24. In one example, the vapor barrier layer 24 can comprise a urethane material. For example, the urethane can comprise Product Number PT6200S, available from Deerfield Urethane. In further example, the vapor barrier layer can comprise vinyl, silicone, Viton®, and/or synthetic or natural rubber. In another example, the vapor barrier layer 24 is chosen to withstand the transfer of vapors or liquids having temperatures of up to about 100° C. or about 325° C. In some examples, the vapor barrier layer 24 can have a thickness of from about 1 mils to about 10 mils. In some examples, the vapor barrier layer can have a thickness of 2 mils or 3 mils.

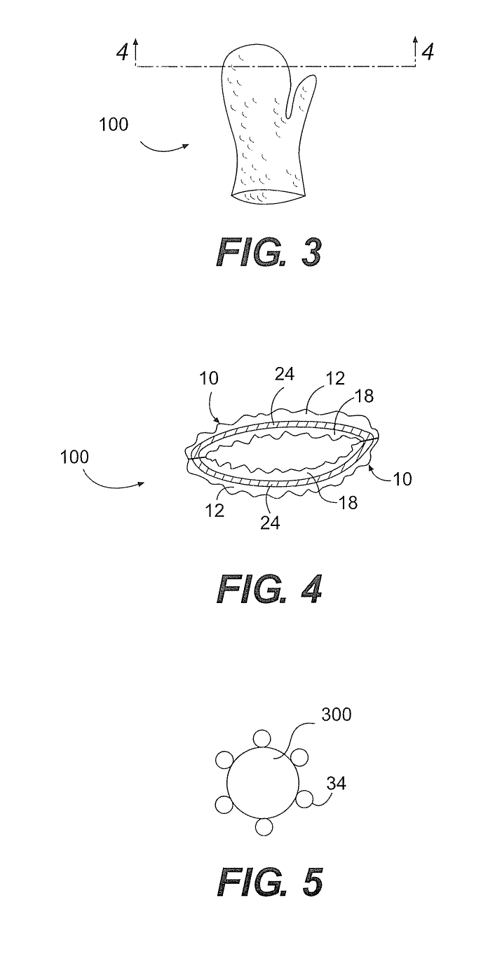

The article 10 can have any suitable shape. For example, the article can be in the shape of an oven mitt, a sleeve, a glove, a towel, or a hot pad. One such shape is illustrated in FIG. 3, which shows an article 100 in the shape of an oven mitt. As shown in FIG. 4, which illustrates cross section A, two articles 10 having first and second layers 12, 18 and a vapor barrier layer 24 can be shaped and attached to form an oven mitt shaped article 100. It will be understood that the article 10 can be shaped and attached in any suitable manner. For example, the article 10 can be cut and sewn to form any desired shape.

In accordance with further embodiments of the invention, methods of providing protection are provided. The methods can comprise utilizing an article to provide protection in a kitchen environment. The article is as described herein. The article can be utilized to provide a user with protection from burns or minimization of burns resulting from handling hot items. For example, the oven mitt 10a, illustrated in FIG. 3, can be utilized to prevent or minimize burns to a user when removing hot items from an oven. The article can be utilized to provide a vapor barrier such that a burn to a user is prevented or minimized. For example, the oven mitt 10a, illustrated in FIG. 3, can be utilized to remove a steaming and heated item from an oven while preventing or minimizing burns to the user. The vapor barrier 24 prevents one of the first or second layers 12, 18 from becoming wet, which can accelerate the transfer of heat. Additionally, the vapor barrier 24 prevents or minimizes the contact of hot steam with a user's hand.

It will be obvious to those skilled in the art that various changes may be made without departing from the scope of the invention, which is not to be considered limited to what is described in the specification.

What is claimed is:

1. An article comprising:
a first layer having a first and second face and a second layer having a first and second face, wherein at least one of the first layer and the second layer comprise fibers having hollow areas, and wherein at least a portion of the hollow areas of at least a portion of the fibers contain an antimicrobial agent; and
a vapor barrier layer having a first and second face, wherein the first face of the first layer is disposed proximate to the first face of the vapor barrier layer and the first face of the second layer is disposed proximate to the second face of the vapor barrier layer, and wherein the first and second layer and the vapor barrier are laminated together such that a vapor barrier between the first and second layer is formed.

2. The article as claimed in claim 1 wherein at least one of the first layer and the second layer comprise from about 15% by weight to about 100% by weight of the fibers having hollow areas.

3. The article as claimed in claim 1 wherein the first layer and the second layer comprise fibers having hollow areas.

4. The article as claimed in claim 1 wherein the layer comprising fibers having hollow areas further comprises additional fibers selected from cotton, wool, polyester, Lycra®, modacrylic, Nomex®, and Kevlar® fibers, or combinations thereof.

5. The article as claimed in claim 4 wherein the fibers having hollow areas and the additional fibers are woven to form a cloth.

6. The article as claimed in claim 5 wherein the fibers having hollow areas and the additional fibers are woven to form a cloth having one of a terry cloth finish, a plain weave finish, and a twill finish.

7. The article as claimed in claim 1 wherein the fibers having hollow areas are selected from polyester, Nomex®, Kevlar®, modacrylic, and/or aramid fibers, or combinations thereof.

8. The article as claimed in claim 1 wherein the antimicrobial agent is selected from silver-based antimicrobial agents, halogenated phenyl ethers, halogenated salicylanilides, sesquiterpene alcohols, halogenated carbanilides, bisphenolic compounds, general phenols, quaternary ammonium compounds, pyridine derivatives, zinc based compounds, polymeric based antimicrobials, and hexachlorophane, or combinations thereof.

9. The article as claimed in claim 8 wherein the antimicrobial agent comprises silver-based antimicrobial agents.

10. The article as claimed in claim 1 wherein the vapor barrier layer is selected from at least one of a urethane, vinyl, silicone, Viton®, synthetic rubber, and natural rubber layer, or combinations thereof.

11. The article as claimed in claim 1 wherein the article is in the shape of an oven mitt.

12. The article as claimed in claim 1 wherein the article is the shape of a sleeve.

13. The article as claimed in claim 1 wherein the article is the shape of a glove.

14. The article as claimed in claim 1 wherein the article has a shape selected to be the shape of one of a towel and a hot pad.

15. An article comprising:
a first layer having a first and second face and a second layer having a first and second face, wherein at least one of the first layer and the second layer comprise fibers that have been treated with an antimicrobial agent such that the antimicrobial agent contacts at least a portion of the fibers; and
a vapor barrier layer having a first and second face, wherein the first face of the first layer is disposed proximate to the first face of the vapor barrier layer and the first face of the second layer is disposed proximate to the second face of the vapor barrier layer, and wherein the first and second layer and the vapor barrier are laminated together such that a vapor barrier between the first and second layer is formed.

16. A method of providing protection, comprising:
utilizing an article to provide protection in a kitchen environment, wherein the article comprises:
a first layer having a first and second face and a second layer having a first and second face, wherein at least one of the first layer and the second layer comprise fibers having hollow areas, and wherein at least a portion of the hollow areas of at least a portion of the hollow fibers contain an antimicrobial agent; and
a vapor barrier layer having a first and second face, wherein the first face of the first layer is disposed proximate to the first face of the vapor barrier layer and the first face of the second layer is disposed proximate to the second face of the vapor barrier layer, and wherein the first and second layer and the vapor barrier are laminated together such that a vapor barrier between the first and second layer is formed.

17. The method as claimed in claim 16 wherein the step of utilizing an article comprises utilizing the article to one of provide burn protection and minimization.

18. The method as claimed in claim 16 wherein the step of utilizing an article comprises utilizing the article to provide a vapor barrier such that a burn to a user is minimized.

19. A method of providing protection, comprising:
utilizing an article to provide protection in a kitchen environment, wherein the article comprises:
a first layer having a first and second face and a second layer having a first and second face, wherein at least one of the first layer and the second layer comprise fibers that have been treated with an antimicrobial agent such that the antimicrobial agent contacts at least a portion of the fibers; and
a vapor barrier layer having a first and second face, wherein the first face of the first layer is disposed proximate to the first face of the vapor barrier layer and the first face of the second layer is disposed proximate to the second face of the vapor barrier layer, and wherein the first and second layer and the vapor barrier are laminated together such that a vapor barrier between the first and second layer is formed.
